(19) United States
(12) Patent Application Publication
(10) Pub. No.: US 2009/0087153 A1
(43) Pub. Date: Apr. 2, 2009

(54) Optical Fiber Microcable with Multilayer Protective Sheath

(75) Inventors: Alexander Weiss, Monchengladbach (DE); Klaus Nothofer, Erkrath (DE); Peter Lausch, Krefeld (DE)

Correspondence Address: SUMMA, ADDITON & ASHE, P.A., 11610 NORTH COMMUNITY HOUSE ROAD, SUITE 200, CHARLOTTE, NC, 28277, US

(73) Assignee: Draka Comteq B.V., Amsterdam (NL)

(21) Appl. No.: 12/187,814

(22) Filed: Aug. 7, 2008

Related U.S. Application Data
(63) Continuation-in-part of application No. PCT/NL2006/000290, filed on Jun. 13, 2006.

(30) Foreign Application Priority Data
Feb. 8, 2006 (NL) 1031109

(51) Int. Cl. G02B 6/44

(52) U.S. Cl. 385/113

(57) ABSTRACT

Disclosed is a central loose tube fiber optic microcable that includes a protective sheath enclosing a plurality of optical fibers. The microcable protective sheath is composed of two layers of different synthetic materials, namely an inner layer having an elasticity modulus of about 1500-3000 MPa and an outer layer having an elasticity modulus of about 600-1200 MPa.

### CROSS-REFERENCE TO PRIORITY APPLICATIONS

This application is a continuation-in-part of pending International Application No. PCT/NL2006/000290 for an Optical Fiber Cable Suited for Blown Installation or Pushing Installation in Microducts of Small Diameter, filed Jun. 13, 2006 (and published Aug. 16, 2007, as Publication No. WO 2007/091880 A1), which itself claims the benefit of Dutch Application No. 1,031,109 (filed Feb. 8, 2006 at the Dutch Patent Office). This nonprovisional application claims the benefit of and incorporates entirely by reference both International Application No. PCT/NL2006/000290 and Dutch Application No. 1,031,109.

### CROSS-REFERENCE TO COMMONLY ASSIGNED APPLICATIONS

This application incorporates entirely by reference the following commonly assigned U.S. patent documents: U.S. Patent Application Publication No. US 2007/0183726 A1 and its related U.S. patent application Ser. No. 11/672,714 for an Optical Fiber Cable Suited for Blown Installation or Pushing Installation in Microducts of Small Diameter, filed Feb. 8, 2007; U.S. patent application Ser. No. 11/780,217 for an Optical Fiber Cable and Method for Modifying the Same, filed Jul. 19, 2007; U.S. Patent Application Publication No. US 2008/0037942 A1 and its related U.S. patent application Ser. No. 11/835,708 for an Optical Fiber Telecommunications Cable, filed Aug. 8, 2007; U.S. Patent Application Publication No. US 2008/0056651 A1 and its related U.S. patent application Ser. No. 11/848,504 for a Loose Tube Optical Waveguide Fiber Cable, filed Aug. 31, 2007; U.S. Patent Application Publication No. US 2008/0056652 A1 and its related U.S. patent application Ser. No. 11/848,740 for a Strengthened Optical Waveguide Fiber Cable, filed Aug. 31, 2007; U.S. patent application Ser. No. 11/938,280 for a Telecommunication Optical Fiber Cable, filed Nov. 10, 2007; U.S. patent application Ser. No. 11/944,185 for a Method and Device for Installing Cable into Cable Guide Tubing, filed Nov. 21, 2007; U.S. Patent Application Publication No. US 2007/0263960 A1 and its related U.S. patent application Ser. No. 11/747,573 for a Communication Cable Assembly and Installation Method, filed May 11, 2007; and U.S. Provisional Patent Application No. 60/969,401 for a Modified Pre-Ferrulized Communication Cable Assembly and Installation Method, filed Aug. 31, 2007.

### FIELD OF THE INVENTION

The present invention relates to optical fiber cables and more specifically to an optical fiber cable particularly suited for blown installation or pushing installation in small-diameter microducts.

### BACKGROUND OF THE INVENTION

Fiber optic cables have been commonly deployed by installing them in ducts, by blowing or pulling, burying them in the ground, or suspending them between above-ground poles. Traditional duct installation, however, uses space inefficiently. Typically, one cable per inner duct has been the maximum capacity, although in some cases two cables per duct have been used (i.e., pulled-in or jetted-in).

Recently, however, optical micro cabling technology has been introduced for the deployment of fiber optic cables to increase utilization of conduit space and to enhance profitability of current and/or future telecommunications infrastructure. This technology involves the use of standard ducts in which microducts are jetted, followed by the jetting of microduct cables or microcables into the microducts. Although originally intended for business access networks (FTTB) and fiber-to-the-home (FTTH), this technology has been used successfully in long-haul applications as well.

Microducts are empty tubes of small outer/inner diameter (e.g., generally in the range of 5/3.5 millimeters to 12/10 millimeters) that can be blown or pushed into empty or partially filled standard ducts. Such microduct cables, or microcables, are installed as needed inside the microduct tubes using blown installation techniques.

As will be known by those having ordinary skill in the art, there are microduct cables having various external diameters (and suited for various microduct inner diameter dimensions) and holding a plurality of optical fibers therein.

For example, U.S. Patent Publication No. 2002/0061231 A1, which is hereby incorporated by reference in its entirety, relates to a microcable including a metal or plastic tube of very small diameter (i.e., preferably between 3.5 millimeters and 5.5 millimeters) coated with a plastic layer (e.g., PTFE). The optical waveguides are then introduced into the tube either after the empty tube has been laid or at the factory.

British Patent Publication No. GB 1,529,101, which is hereby incorporated by reference in its entirety, relates to an optical conductor for use in an optical cable, which includes a light transmission element in the form of a glass fiber or glass fiber bundle and a protective sheath surrounding the fiber or glass fiber bundle. The protective sheath is composed of two layers of different synthetic resin materials, namely an inner layer consisting of polystyrene or a fluorinated polymer, which will slide freely on the glass fiber(s), and an outer layer consisting of a polyamide, a polyterephthalate, polypropylene, or polyethylene.

U.S. Pat. No. 6,334,015, which is hereby incorporated by reference in its entirety, relates to a telecommunication cable having optical fibers contained in a retaining sheath. The retaining sheath tightly grips a predetermined number (N) of optical fibers in a group, (e.g., four, six, eight, or twelve fibers), thereby constituting a compact module. A plurality of such optical fiber modules can be combined within a protective jacket of a telecommunication cable, or can be retained in a cylindrical sheath to form a bundle of several modules, with or without a central reinforcing member. The bundle is combined with other bundles of modules in a protective jacket of a telecommunication cable, which is not regarded as a microcable.

U.S. Pat. No. 6,137,935, which is hereby incorporated by reference in its entirety, relates to an optical cable including at least one optical fiber surrounded by a tubular sheath, wherein a plastic inner layer and a plastic outer layer of the tubular sheath are extruded together around the optical fiber in a single operating step. Tension elements, which extend in the longitudinal direction of the optical cable, are embedded in the tubular sheath in the region between the inner layer and the outer layer.

International Publication No. WO 2005/019894, which is hereby incorporated by reference in its entirety, relates to an optical transmission cable suitable for push/pull installation in a microtube. The disclosed cable's outer sheath, which surrounds at least one optical fiber, is made from a material blend of multiple thermoplastics having a modulus of elasticity of between 1000 MPa and 2500 MPa under normal use conditions, a thermal expansion coefficient of less than 1×10⁻⁴/° C. and a post-extrusion shrinkage coefficient of less than 0.1 percent.

U.S. Pat. No. 5,082,348, which is hereby incorporated by reference in its entirety, relates to an optical cable having a plurality of multifiber units.

European Patent Publication No. EP 1,369,724, which is hereby incorporated by reference in its entirety, discloses an optical fiber structure wherein the cable tube is formed from a soft resin in which inorganic fillers are dispersed.

U.S. Patent Application Publication No. US 2005/0281517, which is hereby incorporated by reference in its entirety, relates to a multilayered buffer tube for use in a fiber optic cable possessing a central strength member.

Other steel tube designs allow up to 72 fibers in a small 5.5-millimeter package that fits into a 10/8 millimeter microproduct. Finally, there are also so-called blown fiber bundles or fiber ribbons consisting of fiber bundles embedded in a common soft matrix material. The latter are not real cables, however, and are not suited for outside cable plant applications; they are not robust, and thus are sensitive to mechanical damage when installed in an outdoor environment.

### SUMMARY OF THE INVENTION

The present invention embraces a microcable suitable for blown installation into small microducts. The present microcable, which can facilitate a high fiber count, has excellent blowing performance and can be sufficiently mechanically robust to be safely installed in an outside plant environment.

In one aspect, the present invention embraces a microcable for installation in small microducts. The microcable includes a protective sheath holding a plurality of optical fibers, the protective sheath being composed of two layers of different synthetic materials (i.e., an inner layer and an outer layer). The protective sheath's inner layer is typically made of a material having an elasticity modulus in the range of 1500 MPa to 10,000 MPa at room temperature, and the outer layer of the protective sheath is typically made of a material having an elasticity modulus in the range of 600 MPa to 1200 MPa at room temperature (i.e., about 20° C.).

Typically, the ratio of the protective sheath's outer diameter to the protective sheath's inner diameter is between about 1.5 and 2.0.

A microcable designed according to the present invention is easily handled by installation personnel of ordinary skill and complies with all major outdoor cable requirements (e.g., is not sensitive to mechanical damage, has high tensile strength and crush resistance, is able to work at an operational temperature between about −30° C. and +60° C.).

The present microcable is made of a combination of sheath materials that are processed in a way that provides tight coupling of the resulting sheath, and at the same time allowing easy sheath removal. The microcable is typically stiff enough to allow long pushing distances without air drag support, yet is flexible enough to provide long distance blowing installation in curved ducts.

The present microcable typically possesses a low thermal expansion coefficient and shrink back to facilitate a wide operating temperature range. Moreover, the present microcable typically has a post-extrusion shrinkage of less than 0.3 percent and a thermal expansion coefficient of less than 1.5×10⁻⁴/K.

In exemplary embodiments of the present microcable, the material of the protective sheath's inner layer is polybutylene terephthalate (PBT), polyethylene terephthalate (PET), polyamide 6 (PA 6), polyamide 12 (PA 12), polycarbonate (PC), or blends thereof, and the material of the protective sheath's outer layer is high-density polyethylene (HDPE), polypropylene (PP), or blends thereof.

If necessary, reinforcement additives can be added to both the material of the inner layer and/or the material of the outer layer. Such reinforcement additives include, for instance, glass, plastic fibers, glass beads, carbon fibers, mineral additives, or mixtures thereof.

The material of the protective sheath's inner layer typically is polyamide 12, and the protective sheath's outer layer is typically HDPE. Such a hard inner layer (i.e., PA 12), provides an extremely smooth inner surface, which reduces or avoids optical-fiber microbending. Because of the double jacket design, and by selecting different combinations and/or dimensions for the respective inner and outer layers, the post-extrusion shrinkage and the thermal expansion coefficient of the microcable can be adjusted over a wide range.

When the microcable according to the present invention is made on a double-extrusion line, the manufacturing costs are extremely low. Furthermore, the adhesion of the inner and outer layers is in an ideal range for easy stripping, yet is sufficient to withstand abrasion. The process for forming the microcable according to the present invention provides a very small diameter variation and a constant geometry over the length of the microcable, thereby resulting in reduced friction.

The microcable's fiber density (i.e., the cross-sectional area of fibers within the cable divided by the cross-sectional area of the cable itself) is typically in a range between 0.1 and 0.2. A higher density tends to limit the operating temperature range.

The foregoing, as well as other characteristics and advantages of the invention and the manner in which the same are accomplished, is further specified within the following detailed description and its accompanying drawings.

### BRIEF DESCRIPTION OF THE DRAWINGS

FIG. 1 depicts a cross-sectional view of an exemplary optical microcabling deployment.

FIG. 2 depicts a cross-sectional view of an exemplary microcable according to the present invention.

### DETAILED DESCRIPTION

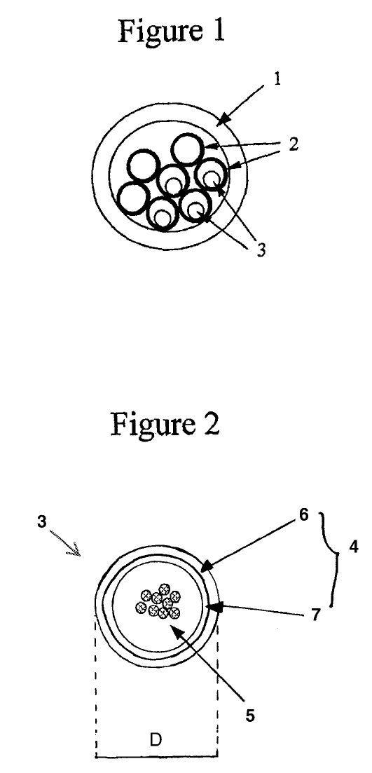

FIG. 1 schematically depicts an example of the microcabling technology for the deployment of optical fiber cables. The configuration depicted in FIG. 1 shows a duct 1 having seven microducts 2 placed therein, with a microcable 3 positioned within four of the microducts 2.

FIG. 2 schematically depicts an exemplary microcable 3 according to the present invention. The exemplary microcable 3 includes a single buffer tube 4 enclosing a plurality of optical fibers 5. The buffer tube 4 (i.e., the protective sheath) is composed of two layers (i.e., an inner layer 7 and an outer layer 6) made of different synthetic materials.

The buffer tube 4 is typically filled with a water-repelling gel, and has a relatively large diameter compared to the (whole) cable cross-section, which allows it to house a high count of optical fibers 5.

The microcable 3 according to the embodiment of the present invention is suitable for blowing and/or pushing installation into small microducts having an inner diameter of 3.5 millimeters or 5.5 millimeters, for example. To facilitate installation into a microduct, the cable diameter and weight of the microcable of the present invention must be as small as possible, yet the microcable typically contains between 12 and 24 fibers (e.g., 12, 16, 20, or 24 optical fibers).

The microcable's small diameter is achieved, for instance, by excluding from the microcable 3 one or more rigid strength elements (i.e., positioned either internally within or externally about the microcable 3). For instance, the present microcable does not employ an extra layer of strength members (e.g., continuous axially extending high tensile strength members) embedded in either the inner layer 7, the outer layer 8, or between these two sheath layers (i.e., between inner layer 6 and outer layer 7).

The optical fibers 5 used are preferably standard single mode or multimode optical fibers with a nominal diameter of between about 200 and 250 microns.

A microcable 3 designed according to the present invention exhibits the advantage of obtaining a cable with an extremely small outer diameter D specially suited for installation in small microducts 2, and that is flexible enough to be easily blown through microducts in outside cable plant applications. Such a microcable 3 further allows operation at low temperatures and provides high protection of the fibers against mechanical damage, microbending, and water.

In the specification and figures, typical embodiments of the invention have been disclosed. The present invention is not limited to such exemplary embodiments. Unless otherwise noted, specific terms have been used in a generic and descriptive sense and not for purposes of limitation.

1. A central loose tube fiber optic microcable for installation in microducts, comprising:
a protective sheath enclosing a plurality of optical fibers, said protective sheath having an inner layer and an outer layer of different synthetic materials;
wherein said inner layer of said protective sheath is made of a material possessing an elasticity modulus of between about 1500 MPa and 3000 MPa at about room temperature;
wherein said outer layer of said protective sheath is made of a material possessing an elasticity modulus of between about 600 MPa and 1200 MPa at about room temperature;
wherein the ratio of said protective sheath's outer diameter to said protective sheath's inner diameter is between about 1.5 and 2.0; and
wherein the fiber density of said microcable is between about 0.1 and 0.2.

2. A microcable according to claim 1, wherein the post-extrusion shrinkage of said microcable is less than about 0.3 percent.

3. A microcable according to claim 1, wherein the thermal expansion coefficient of said microcable is less than about 1.5×10⁻⁴ K⁻¹.

4. A microcable according to claim 1, further comprising water-repelling gel substantially filling the space between said optical fibers and said inner layer of said protective sheath.

5. A microcable according to claim 1, wherein said inner layer of said protective sheath is polybutylene terephthalate (PBT), polyethylene terephthalate (PET), polyamide 6 (PA 6), polyamide 12 (PA 12), or polycarbonate (PC), or blends thereof.

6. A microcable according to claim 1, wherein said outer layer of said protective sheath is high-density polyethylene (HDPE) or polypropylene (PP), or blends thereof.

7. A microcable according to claim 1, further comprising reinforcement additives embedded in said inner layer and/or said outer layer of said protective sheath.

8. A microcable according to claim 7, wherein said reinforcement additives comprise glass fibers, glass beads, carbon fibers, or mineral additives, or mixtures thereof.

9. A microcable according to claim 1, wherein there is no layer of continuous axially extending high tensile strength members embedded in said inner layer, said outer layer, and/or between said inner and said outer layer of said protective sheath.

10. A microcable according to claim 1, wherein said microcable has a fiber count of between about 12 and 24 and an outer diameter of between about 1.5 millimeters and 3.2 millimeters.

11. A method for installing the central loose tube fiber optic microcable according to claim 1, comprising the step of introducing the microcable into a microduct by pushing and/or air blowing.

12. A non-reinforced, central loose tube microcable suitable for microduct installation, comprising:
a protective sheath enclosing a plurality of optical fibers, said protective sheath comprising an inner layer and an outer layer of different synthetic materials;
wherein said protective sheath's inner layer possesses an elasticity modulus of between about 1500 MPa and 3000 MPa at about room temperature;
wherein said protective sheath's outer layer possesses an elasticity modulus of between about 600 MPa and 1200 MPa at about room temperature;
wherein the ratio of said protective sheath's outer diameter to said protective sheath's inner diameter is between about 1.5 and 2.0;
wherein said microcable possesses post-extrusion shrinkage of less than about 0.3 percent, a thermal expansion coefficient of less than about 1.5×10⁻⁴ K⁻¹, and a fiber density of between about 0.1 and 0.2; and
wherein no supplemental strength element is positioned within or about said microcable.

13. A microcable according to claim 12, wherein said microcable has an outer diameter of between about 1.5 millimeters and 3.2 millimeters.

14. A microcable according to claim 12, wherein said inner layer of said protective sheath comprises polyamide 12, and said outer layer of said protective sheath comprises high-density polyethylene.

15. A microcable according to claim 12, further comprising water-repelling gel within said protective sheath, said water-repelling gel substantially surrounding said optical fibers.

16. A method for installing the central loose tube fiber optic microcable according to claim 12, comprising the step of pushing and/or air blowing the microcable into a microduct.

17. A microcabling deployment, comprising:
a microduct; and
a central loose tube microcable positioned within said microduct, said microcable comprising one or more optical fibers loosely positioned within a protective sheath, said protective sheath comprising (i) an inner layer possessing an elasticity modulus of between about 1500 MPa and 3000 MPa at about room temperature and (ii) an outer layer possessing an elasticity modulus of between about 600 MPa and 1200 MPa at about room temperature, wherein the ratio of said protective sheath's outer diameter to said protective sheath's inner diameter is between about 1.5 and 2.0 and wherein no supplemental strength element is positioned within or about said microcable.

18. A microcabling deployment according to claim 17, wherein said microcable possesses a thermal expansion coefficient of less than about 1.5×10⁻⁴ K⁻¹.

19. A microcabling deployment according to claim 17, wherein said microcable possesses a fiber density of between about 0.1 and 0.2.

20. A microcabling deployment according to claim 17, wherein exactly one central loose tube microcable is positioned within said microduct.
